(19) United States
(12) Patent Application Publication
(10) Pub. No.: US 2025/0274005 A1
(43) Pub. Date: Aug. 28, 2025

(54) STRAND ORIENTATION IN A GENERATOR

(71) Applicant: General Electric Renovables España, S.L., Barcelona (ES)

(72) Inventors: Rebecca Ann Nold, Glenville, NY (US); David Allan Torrey, Galway, NY (US); Nidhishri Tapadia, Fremont, CA (US)

(21) Appl. No.: 18/857,878

(22) PCT Filed: Apr. 22, 2022
(86) PCT No.: PCT/US2022/025922

§ 371 Date: Oct. 18, 2024

(51) Int. Cl. H02K 3/04; H02K 3/32; H02K 15/062

(52) U.S. Cl. CPC H02K 3/04; H02K 3/32; H02K 15/062

(57) ABSTRACT

A generator defines an axial direction, a radial direction, and a tangential direction, the generator includes a field and an armature disposed within and spaced apart from the field. The armature includes an armature winding that includes one or more armature coil sides, each armature coil side in the one or more armature coil sides houses one or more turns. Each turn in the one or more turns includes a plurality of strands. Each strand in the plurality of strands being oriented with a radial aspect such that each strand of the plurality of strands is shortest in a tangential direction of the generator. It should be understood that the generator may further include any of the additional features described herein.

### STATEMENT REGARDING FEDERALLY SPONSORED RESEARCH OR DEVELOPMENT

This invention was made with Government support under Contract No. DE-EE0008787 awarded by the United States Department of Energy. The Government has certain rights in this invention.

### FIELD

The present disclosure relates generally to air core machines. More particularly, the present disclosure relates to air core machines having armature windings that include a plurality of electrically conductive strands.

### BACKGROUND

Generally, superconducting field rotating machines, such as superconducting generators and motors (collectively as electric machines), include a plurality of superconducting field coils for generating a static or rotating magnetic field and at least one armature coil for generating a rotating magnetic field or a stationary magnetic field in relation to the motion of the armature that interacts with the field from the superconducting coils. Further, superconducting rotating machines are made by constructing field coils (which typically carry a direct current) of a superconducting material (“superconductor”) instead of the normally-conducting material with an electrical resistance (e.g., copper, aluminum, etc.).

In general, superconducting rotating machines typically take advantage of alternating magnetic polarities established by the superconducting field coils. That is, north poles are located between south poles to create a regular north, south, north, south, etc. field pattern. These alternating polarities are generated by relying on superconducting field windings made of superconductors which conduct current in opposite directions. The magnetic fields generated by the field coils interact with the magnetic poles of the armature coil(s) to create torque. Torque is produced by the interaction of two magnetic fields trying to align. The magnitude of the torque is tied to the strength of the magnetic fields and radius at which they interact. For steady motion, the two magnetic fields must move at the same speed. This is accomplished by making one magnetic field travel in space using windings that carry alternating currents. In the superconducting machines described herein, the field windings carry DC current. The armature windings carry alternating currents, the frequency of which is set by the relative motion of the stationary and rotating members. The magnetic field produced by the field coils improves the torque density of the machine, owing to the much higher current-carrying capability of superconducting wires.

However, many superconducting machines may experience eddy current losses which may induce heat and/or result in overheating or a loss of generator efficiency. Thus, the industry is continuously seeking new and improved superconducting machines that address the aforementioned issues. Accordingly, the present disclosure is directed a generator having an armature winding with conducting strands that are arranged to reduce the losses associated with eddy currents associated with operating in a time-varying magnetic field.

### BRIEF DESCRIPTION

Aspects and advantages of the invention will be set forth in part in the following description, or may be obvious from the description, or may be learned through practice of the invention.

In one aspect, the present disclosure is directed to a generator. The generator defining an axial direction, a radial direction, and a tangential direction. The generator includes a field and an armature spaced apart from the field. The armature has an armature winding that includes one or more armature coil sides. Each armature coil side in the one or more armature coil sides houses one or more turns. Each turn in the one or more turns includes a plurality of strands. Each strand in the plurality of strands being oriented with a radial aspect such that each strand of the plurality of strands is shortest in the tangential direction of the generator.

In another aspect, the present disclosure is directed to a generator. The generator defining an axial direction, a radial direction, and a tangential direction. The generator includes a field and an armature spaced apart from the field. The armature has an armature winding that includes one or more armature coil sides. Each armature coil side in the one or more armature coil sides houses one or more turns. Each turn in the one or more turns includes a plurality of strands. The generator produces a magnetic flux in a direction oblique to a radial direction and the tangential direction of the generator. The magnetic flux has a predominant component in the radial direction. Each strand of the plurality of strands includes a shortest surface that faces the predominant component of the magnetic flux.

In another aspect, the present disclosure is directed to method of manufacturing an armature for a generator, the generator defines an axial direction, a radial direction, and a tangential direction. The method includes a step of arranging a plurality of strands within a turn. The method further includes a step of aligning the turn within a coil side of the armature such that a shortest surface of each strand of the plurality of strands faces the radial direction of the generator.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of a wind turbine in accordance with embodiments of the present disclosure:

FIG. 2 illustrates a cross-sectional view of an embodiment of a generator according to the present disclosures:

FIG. 3 illustrates a cross sectional view of a generator in accordance with embodiments of the present disclosure:

FIG. 4 illustrates a cross-sectional view of a portion of an armature in accordance with embodiments of the present disclosure:

FIG. 5 illustrates an enlarged cross-sectional view of an armature winding in accordance with embodiments of the present disclosure: and

FIG. 6 illustrates a flow diagram of a method of manufacturing an armature for a generator in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Terms of approximation, such as “about,” “approximately,” “generally,” and “substantially,” are not to be limited to the precise value specified. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

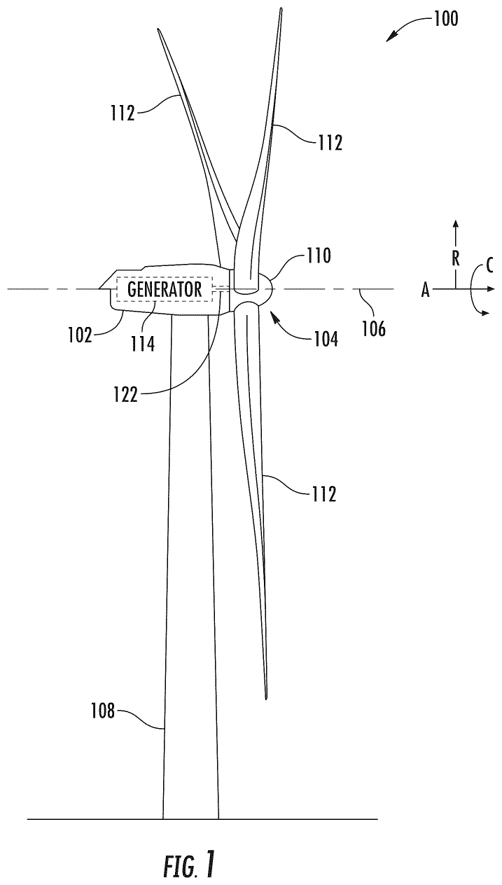

Referring now to the drawings, FIG. 1 illustrates a schematic diagram of a wind turbine 100, in accordance with embodiments of the present disclosure. The wind turbine 100 may be configured to generate electrical power using wind energy. The wind turbine 100 described and illustrated in the embodiment of FIG. 1 includes a horizontal-axis configuration. However, in some embodiments, the wind turbine 100 may include, in addition or alternative to the horizontal-axis configuration, a vertical-axis axis configuration (not shown). The wind turbine 100 may be coupled to, such as, but not limited to, a power grid, for receiving electrical power therefrom to drive operation of wind turbine 100 and/or its associated components and/or for supplying electrical power generated by the wind turbine 100 thereto. The wind turbine 100 may be coupled to an electrical load (not shown) to supply electrical power generated by the wind turbine 100 thereto to the electrical load.

The wind turbine 100 may include a body 102, sometimes referred to as a “nacelle,” and a rotor 104 coupled to the body 102. The rotor 104 is configured to rotate with respect to the body 102 about an axis of rotation 106. In the embodiment of FIG. 1, the nacelle 102 is shown as mounted on a tower 108. However, in some other embodiments, the wind turbine 100 may include a nacelle that may be disposed adjacent to the ground and/or a surface of water.

The rotor 104 may include a hub 110 and a plurality of blades 112 (sometimes referred to as “airfoils”) extending radially outwardly from the hub 110 for converting wind energy into rotational energy. Although the rotor 104 is described and illustrated herein having three blades 112, the rotor 104 may have any number of blades 112. The rotor 104 may have blades 112 of any shape, and may have blades 112 of any type and/or any configuration, whether such shape, type, and/or configuration is described and/or illustrated herein.

In some embodiments, the nacelle 102 may house, fully or partially, one or more of a generator 114, and a shaft 122. The generator 114 may be coupled to the rotor 104 via the shaft 122 and configured to be operated via the rotor 104. For example, rotations of the rotor 104 due to the wind energy in turn cause a rotary element (e.g., an armature) of the generator 114 to rotate via the shaft 122. In some embodiments, the shaft 122 may also include a gear box (not shown). In certain embodiments, use of the gear box may increase the operating speed of the generator 114 and reduce the torque requirement for a given power level. The presence or absence of the gearbox is immaterial to the embodiments of the generator 114 described in the present specification.

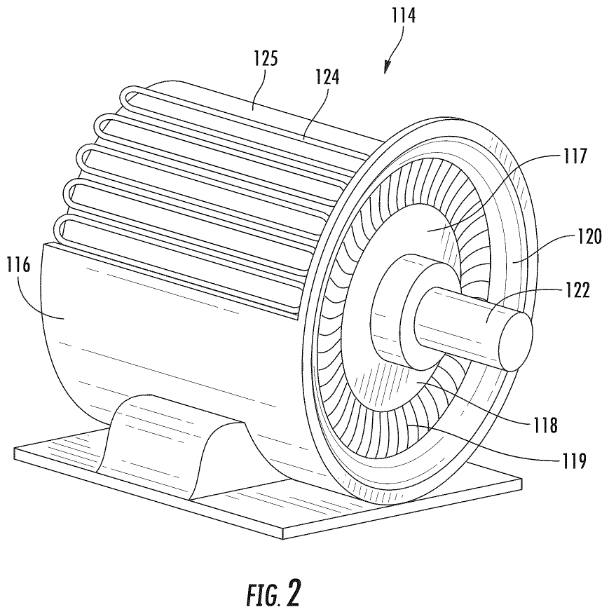

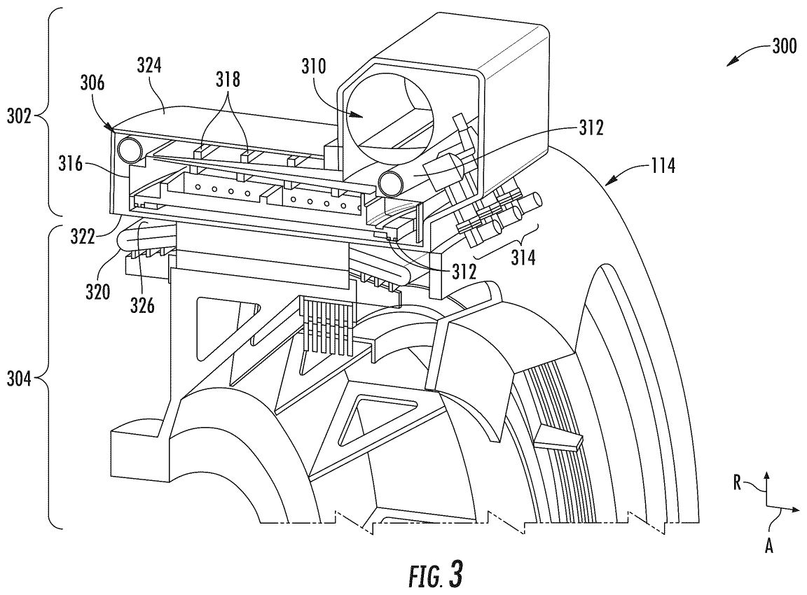

The generator 114 is configured to generate electrical power based at least on the rotations of the armature (shown in FIGS. 2 and 3) relative to the field. In accordance with some embodiments described herein, the generator 114 may be configured to produce increased magnitudes of electrical power in comparison to traditional generators. The generator 114 may be implemented in the form of a synchronous generator. The generator 114 will be described in greater details in conjunction with FIGS. 2 and 3. In various embodiments, the generator 114 may be a superconducting generator.

The wind turbine 100 may define a cylindrical coordinate system having an axial direction A extending along the axis of rotation 106, a radial direction R extending perpendicularly from the axis of rotation 106, and a circumferential direction C extending around the axis of rotation 106. As should be appreciated, the generator 114 may share an axis of rotation 106 with the wind turbine 100, such that the wind turbine 100 and the generator 114 may share the cylindrical coordinate system, and such that elements of the generator 114 may be described with respect to the cylindrical coordinate system.

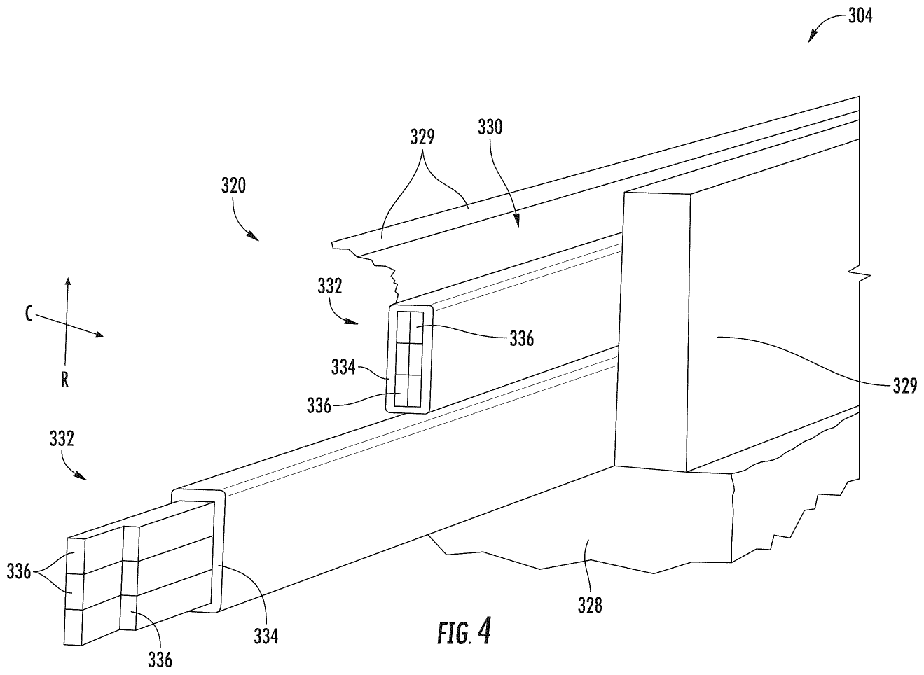

Referring now to FIG. 2, a cutaway, perspective view of an embodiment of a generator 114 is presented, in accordance with one embodiment of the present specification. Without limiting the scope of the present application, the generator 114 may be used in any application other than wind turbines. In particular, as shown, the generator 114 may include a housing 116 for housing the internal components thereof, e.g., such as the armature 118 described herein that may be secured to the rotor shaft 122 and/or the field 120 that may be secured to the housing 116 (which may be a stationary housing). The field 120 may comprise a plurality of field windings 124 formed into coils that may be attached to a support structure 125. Moreover, as shown, the generator 114 may also include at least one winding set. For example, as shown, the winding set(s) may include one or more armature windings 119 formed into coils that may be attached to a support structure 117 (such as the laminated steel support structure 328 having a plurality of non-metallic supports or teeth 329 shown in FIG. 4).

In some embodiments, the armature 118 may be rotatable within a magnetic field provided by the field 120 of the generator 114 (e.g., in an internal rotor configuration). However, in other embodiments, the outer component may be the armature 118 of the generator 114, and the inner component may be the field 120 of the generator 114 (e.g., in an external rotor configuration). Further, as shown, additional space may be defined between the outer component and the inner component so as to allow movement (e.g., rotation) therebetween. In other embodiments, it should be understood that the armature 118 may also be the stationary element operating within a rotating magnetic field established by rotation of the field 120.

Turning now to FIG. 3, a perspective cross-sectional view 300 of a portion of the generator 114 of FIG. 2 is presented, in accordance with one embodiment of the present specification. The generator 114 includes a field 302 (similar to the field 120 of FIG. 2) and an armature 304 (similar to the armature 118 of FIG. 2). The field 302 may be disposed concentric to and radially outward from the armature 304 and may include a vacuum vessel 306 and a superconducting field winding 308. The armature 304 may include an armature winding 320 (such as the armature winding 119 shown in FIG. 2). In some embodiments, the armature winding 320 is non-superconducting winding. In some embodiments, the generator 114 may also include one or more tanks 310 used primarily for storing liquified cryogen, one or more tanks 312 used primarily for storing gaseous cryogen, a cooling apparatus 314 for liquifying cryogen, a thermal shield 316, one or more torque transfer structures 318 such as torque tubes, or combinations thereof. In the embodiment shown in FIG. 3, torque tubes are used as the torque transfer structures 318. Other types of torque transfer structures or torque transfer mechanisms may also be used in place of or in addition to the torque tubes, without limiting the scope of the present specification. In the description hereinafter, the terms “torque transfer structures” and “torque tubes” are interchangeably used.

As depicted in the perspective cross-sectional view 300 of FIG. 3, the vacuum vessel 306 (also referred to as a cryostat) is an annular vessel that houses, either fully or partially, one or more of the superconducting field windings, the tank 310, the one or more conduits, the cooling apparatus 314, the thermal shield 316, and the one or more torque tubes 318. The reference numerals 322 and 324 respectively represent an inner wall and an outer wall of the vacuum vessel 306. In some embodiments, the inner wall 322 faces the armature 304. More particularly, the field 302 and the armature 304 are disposed such that the inner wall 322 of the vacuum vessel 306 is positioned radially opposite to an outer surface 326 of the armature 304.

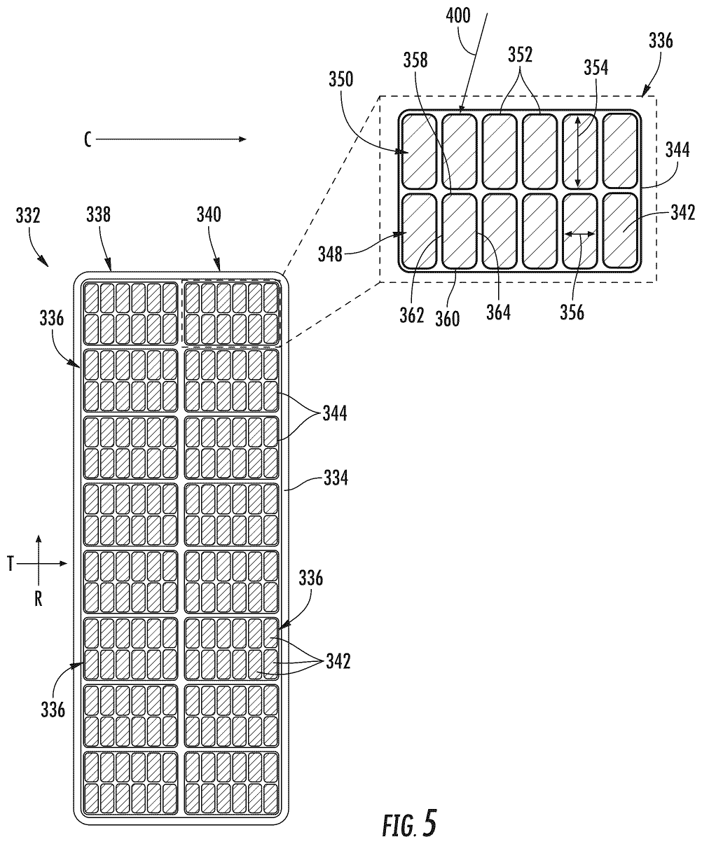

FIG. 4 illustrates a cross-sectional view of a portion of the armature 304, in accordance with embodiments of the present disclosure. As shown, the armature 304 may include a laminated steel support structure or yoke 328 having a plurality of non-metallic supports or teeth 329 extending radially from the yoke 328. The generator 114 having an armature (or field in some embodiments) with non-metallic teeth 329 may be referred to as an “air core design” or an “air core superconducting machine.” Air core superconducting machines may generate a magnetic flux (such as the magnetic flux 400 shown in FIG. 5) that travels in a direction oblique to both the tangential direction T and the radial direction R (i.e., the magnetic flux 400 may travel in a direction that lies between the tangential direction T and the radial direction R). The plurality of teeth 329 may define slots 330 arranged in a circumferential array about the yoke 328. The armature winding 320 may be disposed within slots 330 between the teeth 329. For example, the armature winding 320 may include one or more armature coils, each coil comprised of two armature coil sides 332. One or more armature coil sides 332 may be disposed within the slot 330 between two adjacent teeth 329. For example, in some embodiments, as shown, two armature coil sides 332 may be disposed within the slot 330 and vertically stacked on top of one another. As will be described below in more detail, each armature coil side 332 may include a ground insulation 334 that surrounds and houses a plurality of turns 336. Each turn 336 may include a plurality of electrical conduits or strands 342 (FIG. 5). Each electrical conduit or strand 342 may be composed of an electrically conductive material(s), such as but not limited to an aluminum, copper, an alloy of niobium and tin, an alloy of niobium and titanium, and/or yttrium barium copper oxide (YBCO). In exemplary embodiments, as discussed below, each strand 342 may be longer in the radial direction R than in the circumferential direction C (and/or the tangential direction T, which is a straight direction that is tangential to the circumferential direction C). This will advantageously reduce eddy current losses by ensuring that the shortest side of each strand faces an oncoming flux. It will be appreciated that an armature coil side 332 that contains a single turn is possible. Such a construction may be referred to in the art as a bar.

The teeth 329 provide mechanical structure with which the armature coil sides 332 are held in position. Further, the teeth 329 will participate in the thermal management of the armature coil sides 332. It will be appreciated that the mechanical structure and thermal management can be created in other ways without limiting the scope of the invention.

FIG. 5 is an enlarged cross-sectional view of an armature coil side 332 in a radial-tangential plane of the generator 114, in accordance with embodiments of the present disclosure. As discussed above, the radial direction R may be perpendicular (or orthogonal) to the axis of rotation 106 of the generator 114 (FIG. 1). The tangential direction T may be a straight direction that is tangential to the curved circumferential direction C.

As shown, the armature coil side 332 may house one or more turns 336. For example, the armature coil side 332 may include a ground insulation 334 (that defines an exterior surface of the armature coil side 332), and the one or more turns 336 may be disposed within the ground insulation 334 (i.e., the ground insulation 334 surrounds the one or more turns 336). The ground insulation 334 may define a generally rectangular cross-sectional shape. For example, the ground insulation 334 may form a hollow rectangle (with the plurality of turns 336 disposed inside), such that the long sides of the ground insulation 334 are generally parallel to the radial direction R and the short sides of the ground insulation 334 are generally parallel to the tangential direction T.

In certain embodiments, as shown in FIG. 5, the one or more turns 336 may be a plurality of turns 336, which may be arranged in one or more columns. Alternatively, in some embodiments, the plurality of turns 336 may be arranged in a singular column. For example, the armature coil side 332 may include a first column 338 of turns 336 and a second column 340 of turns 336, with each column of turns having eight turns 336 radially stacked together, such that the armature coil side 332 may house a total of sixteen turns 338. However, while the armature coil side 332 shown in FIG. 5 includes sixteen turns 338 arranged in two radial columns, it should be appreciated that the armature coil side 332 may include any number of turns 338 arranged in any number of columns and/or rows and is not necessarily limited to any particular number of turns 338 or number of columns and/or number of rows unless specifically recited in the claims.

Each turn 338 in the one or more turns 338 may include a plurality of strands 342. For example, each turn 338 may include a turn insulation 344, and the plurality of strands 342 may be disposed within the turn insulation 344. Stated otherwise, the turn insulation 344 may surround the plurality of strands 342. The turn insulation 344 may advantageously protect against turn-to-turn or turn-to-ground electrical shorts. The turn insulation 344 may define a generally rectangular cross-sectional shape. For example, the turn insulation 344 may form a hollow rectangle (with the plurality of strands 342 disposed inside), such that the long sides of the turn insulation 344 are generally parallel to the tangential direction T and the short sides of the turn insulation 344 are generally parallel to the tangential direction R. If the number of turns 338 in the armature coil side 332 is equal to one, the turn insulation 344 may be omitted and only ground insulation will be used.

In exemplary embodiments, each turn 338 of the one or more turns 338 may include one or more tiers of radially stacked strands 342. Particularly, each turn 338 may include a first tier 348 and a second tier 350 radially stacked on the first tier 348, and each tier 348 and 350 may include six strands 342. However, while the turns 338 shown in FIG. 5 include twelve strands 342 arranged in two tiers, it should be appreciated that the turns 342 may include any suitable number of strands 342 arranged in any number of tiers and is not necessarily limited to any particular number of strands 342 or number of tiers unless specifically recited in the claims.

Each of the strands 342 may be a singular wire formed of an electrically conductive material, such as metal or metal alloys (such as but not limited to aluminum or copper). In some embodiments, one or more of the strands 342 may be solid (i.e., not hollow or containing voids). In other embodiments, one or more of the strands 342 may be hollow. Each of the strands 342 may be disposed within a strand insulation 352, such that the strand insulation 352 surrounds the strand 342. The strand insulation 352 may be composed of any suitable insulating material, which may include a varnish, enamel compounds, glass, and/or other suitable insulating material. The strand insulation 352 may advantageously protect against stand-to-strand electrical shorts that would allow current to move from one strand to another.

It will be appreciated that the strands 342 within each turn 338 may be transposed such that over some length of the strand bundle each strand occupies each position approximately the same amount. Transposition seeks to balance the flux linking each strand so the voltages induced in the strands are nearly equal. The disclosed invention accommodates such techniques.

In exemplary embodiments, each strand 342 of the plurality of strands 342 oriented with a radial aspect (or may be oriented radially), such that each strand 342 of the plurality of strands 342 is shortest in the tangential direction T (and/or each strand 342 may be longest in the radial direction R). For example, in some embodiments, each strand may be oriented at least partially radially, such that a longitudinal centerline of each of the strands is within 40° of the radial direction, or such as within 30° of the radial direction, or such as within 20° of the radial direction, or such as within 10° of the radial direction. In exemplary embodiments, each strand of the plurality of strands 342 may be oriented entirely radially, such that a longitudinal centerline of each strand is parallel with the radial direction R, and such that each of the strands 342 are shortest in the tangential direction T (and/or longest in the radial direction R). each strand 342 of the plurality of strands 342 may define a radial length 354 (i.e., a length measured in the radial direction R) and a tangential length 356 (i.e., a length measured in the tangential direction T). The radial length 354 may be longer than the tangential length 356, such as 50% longer, or such as 100% longer, or such as 200% longer, or such as 300% longer, or such as 400% longer, or such as 500% longer, or such as 600% longer, or such as 700% longer. Stated otherwise, each strand 342 may define an aspect ratio between the radial length 354 and the tangential length 356 that is between about 1 and about 6, or such as between about 1.5 and about 5.5, or such as between about 2 and about 5, or such as between about 2.5 and about 4.5.

In many embodiments, as shown in FIG. 5, each strand 342 may define a rectangularly shaped cross-sectional area (e.g., in the radial-tangential plane). For example, each strand 342 may include a radially outer surface 358, a radially inner surface 360, and first side surface 362, and a second side surface 364. In various embodiments, the radially outer surface 358 of strands 342 in the first tier 348 may contact the radially inner surface 360 of strands 342 in the second tier 350. Both the radially outer surface 358 and the radially inner surface 360 may extend generally tangentially (e.g., along the tangential direction) from the first side surface 362 to the second side surface 364. The radially outer surface 358 and the radially inner surface 360 may be generally parallel to one another, such that the radial length 354 is constant from the first side surface 362 to the second side surface 364. Likewise, both the first side surface 362 and the second side surface 364 may extend generally radially (e.g., along the radial direction) from the radially inner surface 360 to the radially outer surface 358. The first side surface 362 and the second side surface 364 may be generally parallel to one another, such that the tangential length 356 is constant from the radially inner surface 360 to the radially outer surface 358.

As shown in FIG. 5, the generator 114 may produce a magnetic flux 400 in a direction oblique to the radial direction R and the tangential direction T of the generator 114 (and the wind turbine 100). For example, the magnetic flux 400 may be oriented predominantly radially (i.e., aligned more closely to the radial direction R than the tangential direction T). Particularly, the magnetic flux 400 may be oriented between about 20° and about 40° from the radial direction R, or such as between about 25° and about 35° from the radial direction R, or such as about 30° from the radial direction. In this way, the magnetic flux 400 may have a predominant component in the radial direction R (e.g., the vector of magnetic flux 400 may have a radial component and a tangential component, and the radial component may be larger).

In exemplary embodiments, each strand 342 of the plurality of strands 342 may include a shortest surface (e.g., the radially inner surface 360 and/or the radially outer surface 358) that faces (e.g., is generally perpendicular to) the predominant component of the magnetic flux 400. In this way, the magnetic flux 400 may impinge upon the shortest surface of the strands 342, which may advantageously reduce eddy current losses. For example, both the radially inner surface 360 and/or the radially outer surface 358 may be generally perpendicular to the predominant component (e.g., the radial component) of the magnetic flux 400. Stated otherwise, the magnetic flux 400 may be closer to perpendicular to the radially inner surface 360 and/or the radially outer surface 358 than parallel.

In operation, the generator 114 may include an armature that has non-metallic (or magnetic) teeth (referred to as an air core design) such that the magnetic flux 400 will intersect the armature coil side 332 from a direction that is oblique to the radial direction R and oblique to the tangential direction T. Accordingly, orienting the plurality of strands 342 with the shortest surface facing a predominant component of the magnetic flux 400 may greatly reduce eddy current losses. For example, because eddy current loss varies with the square of the size of the conductor, presenting the smallest surface of the strands 342 towards the magnetic flux 400 may advantageously reduce eddy current losses, thereby avoiding overheating and increasing the operational efficiency of the generator 114.

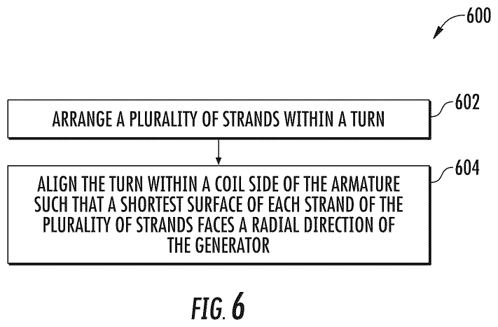

Referring now to FIG. 6, a flow diagram of one embodiment of a method 600 of manufacturing an armature for a generator is illustrated in accordance with aspects of the present subject matter. In general, the method 600 will be described herein with reference to the wind turbine 100, the generator 114, and the armature 118 described above with reference to FIGS. 1 through 5. However, it will be appreciated by those of ordinary skill in the art that the disclosed method 600 may generally be utilized with any suitable wind turbine, generator, and/or may be utilized in connection with a system having any other suitable system configuration. In addition, although FIG. 6 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, the method 600 may include at (602) arranging a plurality of strands within a turn. The plurality of strands may be stacked on top of one another within a turn such that the shortest surfaces are in contact with one another (e.g., the inner/outer radial surfaces). In some implementations, the strands may be inserted, wrapped, or otherwise positioned within the turn such that the turn may house or insulate the plurality of strands. In some embodiments, each strand may be coated and/or sprayed with a fluid (such as a resin) before being positioned within the turn.

In exemplary implementations, the method 600 may further include at (604) aligning the turn within a coil side of the armature such that a shortest surface of each strand of the plurality of strands faces the radial direction of the generator. In some implementations, aligning the turn within a coil side may further include positioning the coil side within the generator such that each strand is oriented having the longest side aligned (e.g., parallel) to the radial direction and the shortest side facing (e.g., perpendicular) to the radial direction.

In some implementations, the method 600 may further include positioning the coil side onto a yoke or laminated steel support structure between two non-metallic (or magnetic) teeth that extend radially outwardly from the yoke. For example, the coil side may be positioned between the non-metallic teeth such that the longest side of each strand is generally parallel to a longest side of the teeth. Particularly, the coil side may be positioned between the non-metallic teeth such that the shortest side of each strand faces a radial direction of the generator.

Further aspects of the invention are provided by the subject matter of the following clauses:

Clause 1. A generator, the generator defining an axial direction, a radial direction, and a tangential direction, the generator comprising:

a field: and

an armature spaced apart from the field, the armature having an armature winding that includes one or more armature coil sides, each armature coil side in the one or more armature coil sides houses one or more turns, each turn in the one or more turns comprising a plurality of strands, each strand in the plurality of strands being oriented with a radial aspect such that each strand of the plurality of strands is shortest in the tangential direction of the generator.

Clause 2. The generator as in clause 1, wherein the generator produces a magnetic flux in a direction oblique to a radial direction and the tangential direction of the generator, the magnetic flux having a predominant component in the radial direction, and wherein each strand of the plurality of strands includes a shortest surface that faces the predominant component of the magnetic flux.

Clause 3. The generator as in any of the preceding clauses, wherein each strand in the plurality of strands defines a radial length and a tangential length, and wherein the radial length is longer than the tangential length.

Clause 4. The generator as in any of the preceding clauses, wherein each strand in the plurality of strands defines a rectangularly shaped cross-sectional area.

Clause 5. The generator as in any of the preceding clauses, wherein each turn of the one or more turns includes one or more tiers of strands.

Clause 6. The generator as in clause 5, wherein the one or more tiers of strands are radially stacked.

Clause 7. The generator as in any of the preceding clauses, wherein each strand in the plurality of strands is disposed within a strand insulation.

Clause 8. The generator as in any of the preceding clauses, wherein each turn in the one or more turns is disposed within a turn insulation.

Clause 9. The generator as in any of the preceding clauses, wherein the one or more turns is a plurality of turns arranged in one or more columns.

Clause 10. The generator as in any of the preceding clauses, wherein each armature coil side of the one or more armature coil sides further comprises a ground insulation, and wherein each turn of the one or more turns is disposed within the ground insulation.

Clause 11. A generator, the generator defining an axial direction, a radial direction, and a tangential direction, the generator comprising:

a field; and

an armature spaced apart from the field, the armature having an armature winding that includes one or more armature coil sides, each armature coil side in the one or more armature coil sides houses one or more turns, each turn in the one or more turns comprising a plurality of strands, wherein the generator produces a magnetic flux in a direction oblique to a radial direction and the tangential direction of the generator, the magnetic flux having a predominant component in the radial direction, and wherein each strand of the plurality of strands includes a shortest surface that faces the predominant component of the magnetic flux.

Clause 12. The generator as in clause 11, wherein each strand in the plurality of strands being oriented with a radial aspect such that each strand of the plurality of strands is shortest in the tangential direction of the generator.

Clause 13. The generator as in clause 12, wherein each strand in the plurality of strands defines a radial length and a tangential length, and wherein the radial length is longer than the tangential length.

Clause 14. The generator as in clauses 11-13, wherein each strand in the plurality of strands defines a rectangularly shaped cross-sectional area.

Clause 15. The generator as in clauses 11-14, wherein each turn of the one or more turns includes one or more tiers of strands.

Clause 16. The generator as in clause 15, wherein the one or more tiers of strands are radially stacked.

Clause 17. The generator as in clauses 11-16, wherein each strand in the plurality of strands is disposed within a strand insulation.

Clause 18. The generator as in clauses 11-17, wherein each turn in the one or more turns is disposed within a turn insulation.

Clause 19. The generator as in clauses 11-18, wherein the one or more turns is a plurality of turns arranged in one or more columns.

Clause 20. A method of manufacturing an armature for a generator, the generator defining an axial direction, a radial direction, and a tangential direction, the method comprising:

arranging a plurality of strands within a turn; and

aligning the turn within a coil side of the armature such that a shortest surface of each strand of the plurality of strands faces the radial direction of the generator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A generator, the generator defining an axial direction, a radial direction, and a tangential direction, the generator comprising:
a field; and
an armature spaced apart from the field, the armature having an armature winding that includes one or more armature coil sides, each armature coil side in the one or more armature coil sides houses one or more turns, each turn in the one or more turns comprising a plurality of strands, each strand in the plurality of strands being oriented with a radial aspect such that each strand of the plurality of strands is shortest in the tangential direction of the generator.

2. The generator as in claim 1, wherein the generator produces a magnetic flux in a direction oblique to a radial direction and the tangential direction of the generator, the magnetic flux having a predominant component in the radial direction, and wherein each strand of the plurality of strands includes a shortest surface that faces the predominant component of the magnetic flux.

3. The generator as in claim 1, wherein each strand in the plurality of strands defines a radial length and a tangential length, and wherein the radial length is longer than the tangential length.

4. The generator as in claim 1, wherein each strand in the plurality of strands defines a rectangularly shaped cross-sectional area.

5. The generator as in claim 1, wherein each turn of the one or more turns includes one or more tiers of strands.

6. The generator as in claim 5, wherein the one or more tiers of strands are radially stacked.

7. The generator as in claim 1, wherein each strand in the plurality of strands is disposed within a strand insulation.

8. The generator as in claim 1, wherein each turn in the one or more turns is disposed within a turn insulation.

9. The generator as in claim 1, wherein the one or more turns is a plurality of turns arranged in one or more columns.

10. The generator as in claim 1, wherein each armature coil side of the one or more armature coil sides further comprises a ground insulation, and wherein each turn of the one or more turns is disposed within the ground insulation.

11. A generator, the generator defining an axial direction, a radial direction, and a tangential direction, the generator comprising:
a field: and
an armature spaced apart from the field, the armature having an armature winding that includes one or more armature coil sides, each armature coil side in the one or more armature coil sides houses one or more turns, each turn in the one or more turns comprising a plurality of strands, wherein the generator produces a magnetic flux in a direction oblique to a radial direction and the tangential direction of the generator, the magnetic flux having a predominant component in the radial direction, and wherein each strand of the plurality of strands includes a shortest surface that faces the predominant component of the magnetic flux.

12. The generator as in claim 11, wherein each strand in the plurality of strands being oriented with a radial aspect such that each strand of the plurality of strands is shortest in the tangential direction of the generator.

13. The generator as in claim 11, wherein each strand in the plurality of strands defines a radial length and a tangential length, and wherein the radial length is longer than the tangential length.

14. The generator as in claim 11, wherein each strand in the plurality of strands defines a rectangularly shaped cross-sectional area.

15. The generator as in claim 11, wherein each turn of the one or more turns includes one or more tiers of strands.

16. The generator as in claim 15, wherein the one or more tiers of strands are radially stacked.

17. The generator as in claim 11, wherein each strand in the plurality of strands is disposed within a strand insulation.

18. The generator as in claim 11, wherein each turn in the one or more turns is disposed within a turn insulation.

19. The generator as in claim 11, wherein the one or more turns is a plurality of turns arranged in one or more columns.

20. A method of manufacturing an armature for a generator, the generator defining an axial direction, a radial direction, and a tangential direction, the method comprising:
arranging a plurality of strands within a turn; and
aligning the turn within a coil side of the armature such that a shortest surface of each strand of the plurality of strands faces the radial direction of the generator.
